(19) United States
(12) Patent Application Publication
(10) Pub. No.: US 2013/0258718 A1
(43) Pub. Date: Oct. 3, 2013

(54) SYSTEM, METHOD, AND APPARATUS FOR POWERING EQUIPMENT DURING A LOW VOLTAGE EVENT

(71) Applicant: Joshua Brian Pankratz, Fort Collins, CO (US)

(72) Inventor: Joshua Brian Pankratz, Fort Collins, CO (US)

(73) Assignee: ADVANCED ENERGY INDUSTRIES, INC., Fort Collins, CO (US)

(21) Appl. No.: 13/435,380

(22) Filed: Mar. 30, 2012

(51) Int. Cl. H02M 7/44; H02M 3/22

(52) U.S. Cl. 363/15; 363/95

(57) ABSTRACT

Low voltage ride through systems, methods, and apparatus are disclosed. An exemplary method includes applying real power from a photovoltaic array to an AC grid with an inverter, detecting a sag in the voltage in the AC grid, and responsive to the sag in the voltage in the AC grid, power from the photovoltaic array is utilized to provide power to at least one inverter-related component. When the sag in the voltage has abated, real power from the photovoltaic array is applied once again to the AC grid.

### BACKGROUND

1. Field

The present invention relates generally to photovoltaic systems, and more specifically to management of low voltage events.

2. Background

In electrical distribution systems, the voltage in the distribution grid may be temporarily reduced in one, two, or all three phases of the grid due to a fault or load change in the grid. The severity of the voltage dip may be defined by the voltage level during the dip (which may go down to zero) and the duration of the dip.

Increasingly, photovoltaic electricity generation systems are contributing to the supply of power in existing electrical distribution systems. When a low voltage event occurs on the distribution grid, these photovoltaic systems are required to ride through the temporary low voltage event by, for example, staying operational and staying connected to the grid.

The particular requirements for low voltage ride through (LVRT) depend upon the particular grid operator and/or governmental regulatory requirements. But these events are temporary in nature, and as a consequence, some typical approaches have relied on stored energy in components of the photovoltaic system. Other approaches to powering components of the photovoltaic system, however, utilize uninterruptable power supplies. But both of these approaches have disadvantages that will only become more problematic as additional photovoltaic systems are deployed.

### SUMMARY

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In some embodiments, the invention may be characterized as a photovoltaic inverter with low-voltage-ride-through capability. The inverter in this embodiment includes an input to couple to a photovoltaic array, an output to couple to an AC grid, an inverter portion to convert a DC voltage at the input to an AC voltage at the output, and at least one management component to manage at least one aspect of the inverter portion. In addition, the inverter includes a low voltage ride through component including a power conversion component that utilizes, when there is a voltage sag in the AC grid, power from the photovoltaic array to apply power to the at least one management component.

Another aspect of the present invention includes a method for powering components of an inverter during a low voltage event. The method includes applying real power from a photovoltaic array to an AC grid with the inverter, detecting a sag in the voltage in the AC grid, utilizing, responsive to the sag in the voltage in the AC grid, power from the photovoltaic array to provide power to at least one inverter-related component, and applying, when the sag in the voltage has abated, the real power from the photovoltaic array to the AC grid with the inverter.

### BRIEF DESCRIPTION OF THE DRAWINGS

FIG. 1 is a block diagram depicting an exemplary embodiment of the present invention;

FIG. 2 is a block diagram depicting additional details of an exemplary embodiment of components described with reference to FIG. 1;

FIG. 3 is a block diagram depicting additional details of another embodiment of components described with reference to FIG. 1;

FIG. 4 is a block diagram depicting additional details of yet another embodiment of components described with reference to FIG. 1; and

FIG. 5 is a flowchart depicting a method that may be carried out in connection with any of the embodiments described with reference to FIGS. 1-4.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

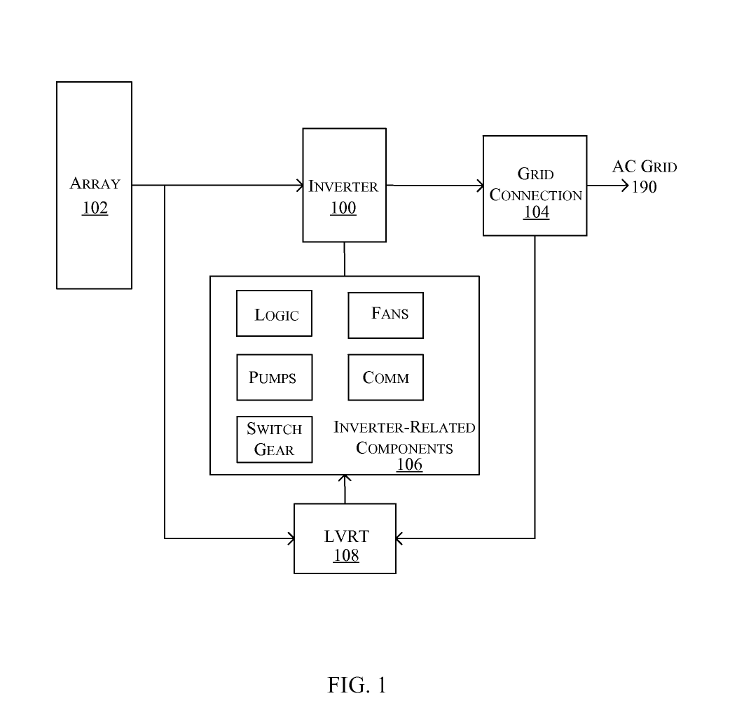

Referring first to FIG. 1, it is a block diagram depicting an exemplary embodiment of the present invention. As shown, an inverter 100 is coupled between a photovoltaic array 102 and a grid connection 104, and associated with the inverter 100 are inverter-related components 106 such as control logic, fans, pumps, communication components and switchgear. In addition, a low-voltage-ride-though (LVRT) component 108 is shown coupled to the photovoltaic array 102, the inverter-related components 106, and the grid connection 104.

In general, the photovoltaic array 102 generates DC power from a plurality of photovoltaic panels as is well known to those of ordinary skill in the art. The photovoltaic array 102 may be realized by any of a variety of different types of panels that are arranged in and of a variety of topologies including unipolar and bipolar topologies. The inverter 100 generally operates to convert the DC power from the photovoltaic array 102 to AC power that is applied to an AC grid 190.

Each of the inverter-related components 106 performs a function related to managing an aspect of the operation of the inverter, and as a consequence, the inverter-related components 106 are also referred to herein as management components 106. For example, the control logic manages control of the inverter and the inverter-related components 106; the fans and pumps help to manage heating and/or cooling of the inverter and inverter-related components 106; the communication component helps an operator of the inverter to communicate with the inverter 100 and the inverter-related components 106; and the switchgear enable connections between the inverter 100 and the array 102 and the inverter 100 and the grid connection 104 to be managed.

The LVRT component 108 generally functions to provide power to one or more of the inverter-related components 106 during a transient, low-voltage condition at the AC grid 190 so that selected ones of the inverter related components 106 remain operable during the low-voltage condition. In this way, the inverter 100 remains capable of quickly re-applying real power to the AC grid 190 when the low-voltage condition is no longer present. But unlike typical, prior approaches, the LVRT component 108 in this embodiment utilizes power from the photovoltaic array 102 to apply power to one or more (or all) of the inverter-related components 106.

As a consequence, the LVRT component 108 neither relies on battery power like some prior approaches nor relies on the sagging voltage from the AC grid 190 to power the inverter-related components 106 like other approaches. Although the approaches that utilize a battery-based uninterruptable power supply work well in an environmentally controlled and conditioned space, when the inverter 100 is located in an unconditioned, remote location that faces temperature extremes, such as a desert, batteries (which are also expensive) lose life quickly. And the approaches that rely on AC power from the grid obviate the need for expensive batteries, but when the grid power is unreliable, so is the power for essential functions that are provided by one or more of the inverter-related components 106. Thus, the present LVRT 108 component removes the problems that are inherent in the battery-based and AC-grid based LVRT systems.

More specifically, traditional power for the necessary functions of a photovoltaic inverter come from the AC grid 190 at the cost of a transformer to set the correct voltages and a simple AC-to-DC rectifier for unregulated DC power. This approach is cost effective and reliable, but the drawback is that it is dependent on the AC grid 190 for power during operation. If there are momentary faults or interruptions in the power of the AC grid, the power for the necessary functions to run the inverter may be interrupted and the inverter is tripped off line.

Due to new requirements, some jurisdictions may require low voltage ride through (LVRT) and even zero voltage ride through (ZVRT). These requirements require the inverter to continue to operate and remain on line for disturbances of several seconds. To keep the necessary functions of the inverter powered, a reliable source of power is required. This traditionally is accomplished is a number of ways. For example, an external AC source that is not tied directly to the output of the inverter has been used. This approach will work if the fault is between the inverter and the local distribution transformer. But if the fault/disturbance is beyond the distribution transformer and it affects a wider area, the external AC source is also adversely affected.

With respect to the use of an uninterruptable power supply (UPS), in remote outdoors locations, these are expensive and the environmental conditions diminish service life of the UPS systems quickly. And the other traditional approach of using batteries and stored energy (e.g., in capacitors) to keep the necessary voltages up faces the problem that the required batteries and capacitors are large and are not tolerant of the environmental conditions of the remote locations that inverters are placed into. There are yet other approaches that are so unviable that they are not practical solutions, for example, the use of diesel generators. As a consequence, embodiments of the LVRT component 108 discussed herein provide many improvements and advantages over prior approaches.

In the present embodiment, when a voltage sag (also referred to as a low-voltage condition) occurs on the AC grid 190, the LVRT component 108 utilizes power from the array 102 to provide power to the inverter-related components 106. In some embodiments, the LVRT component 108 utilizes power from the AC grid 190 via the grid connection 104 (e.g., a transformer) until there is a low-voltage condition, and then the LVRT component 108 utilizes power from the array 102 until the voltage level on the AC grid 190 returns to a nominal value. In other implementations, the LVRT component 108 utilizes power from the array 102 whenever the array 102 is capable of providing power to the inverter-related components. For example, the LVRT component 108 may utilize power from the array 102 during daylight hours when the array is generating electricity and then utilize power from the AC grid 190 at night when the array 102 cannot generate sufficient power.

As discussed further herein, the inverter-related components 106 may include both DC and AC components. As a consequence, the LVRT component 108 may include power conversion components to convert the DC power from the array 102 to one or more DC voltages that may be utilized by the DC inverter-related components, and may convert the DC power from the array 102 to AC power to provide power to one or more of the AC inverter-related components. In yet alternative implementations, the LVRT component 108 may only apply power to DC inverter-related components during the low voltage condition and simply remove power from the AC inverter-related components during the low voltage condition.

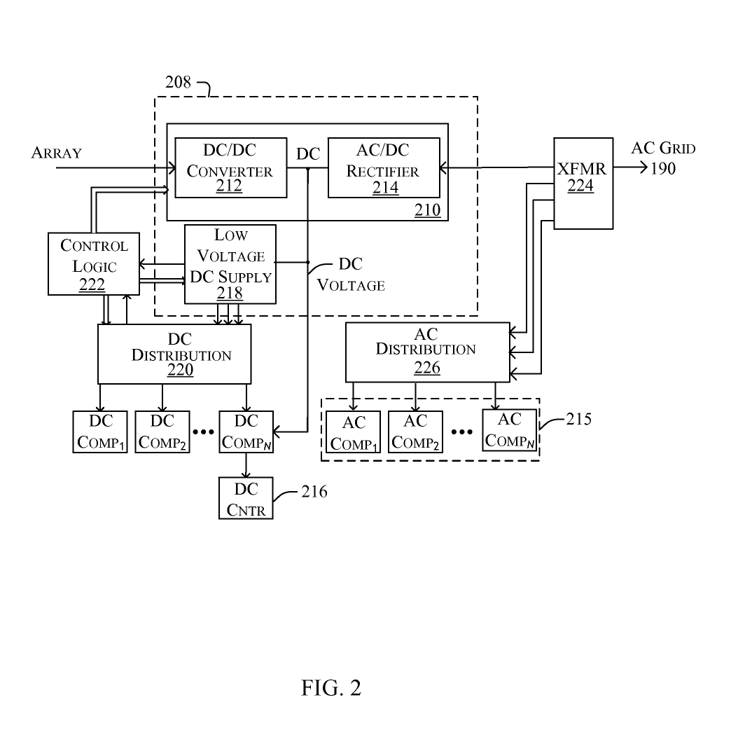

Referring to FIG. 2, for example, shown is an LVRT component 208 that includes a power conversion component 210 that includes a DC-to-DC converter 212 and an AC-to-DC rectifier 214 that are coupled at a common node, and each are configured to generate DC power that is utilized to power DC inverter-related components. As depicted, the DC inverter-related components may include control logic and N other DC components that the LVRT component 208 provides power to during a low voltage condition. But in this embodiment, AC inverter-related components 215 are not powered by the LVRT component 208.

During ongoing operation, one or more of the AC inverter-related components 215 may be required to operate in order for the inverter to continue to properly operate, and as a consequence, AC power is obtained from a transformer 224 that is coupled to the AC grid 190. As shown, the transformer 224 may include multiple taps so that a plurality of voltages (e.g., 170 and 240 VAC) may be applied to the AC inverter-related components from an AC distribution component 226, but during the brief period of time (e.g., less than the duration of the event, which may be just a few seconds) during which the LVRT component 208 provides power to the DC inverter related components, some or all of the AC inverter related components (e.g., cooling fans and pumps) do not need to operate. As a consequence, the LVRT component 208 may be realized without AC-power-generating components that generate AC voltages from DC voltages; thus reducing costs and maintenance.

Although not required, in this embodiment, the DC-to-DC converter 212 and the AC-to-DC rectifier 214 collectively provide a DC voltage (e.g., 240 VDC) that may be utilized to power components that utilize DC voltages such as one or more switchgear contactors 216, and a low voltage DC supply 218 converts the DC power to one or more other DC voltages (e.g., 5, 12, 15, −15, and 24 VDC) that are distributed by a DC distribution component 220 to DC components (DC comp_{1-N} and control logic 222). The N DC inverter-related components may include, for example, relays to control DC contactors (e.g., DC contactor 216) and communication components.

In many implementations, the DC-to-DC converter 212 applies power from the array 102 only when the voltage at the AC grid 190 drops below a threshold value. For example, the DC-to-DC converter 212 may be controlled to apply power when a voltage at the AC grid 190 falls below 80 percent. But other threshold values, such as 90 or 70 percent of nominal voltage, are certainly contemplated. As a consequence, the DC-to-DC converter 212 in FIG. 2 is relied upon only when power from the AC grid 190 is insufficient and/or unreliable; thus the DC-to DC converter 212 may have a longer expected lifetime as compared to other embodiments. Although not required, the DC-to-DC converter 212 in many implementations is configured to operate with nominal array voltages (e.g., between 500 and 1200 VDC) and provide the necessary control voltage (e.g., 240 VDC) that is used to power switchgear (e.g., DC contactor). It should be recognized that the nominal array voltages and necessary control voltages may vary depending upon the type of array that is implemented and the operating voltages of the system.

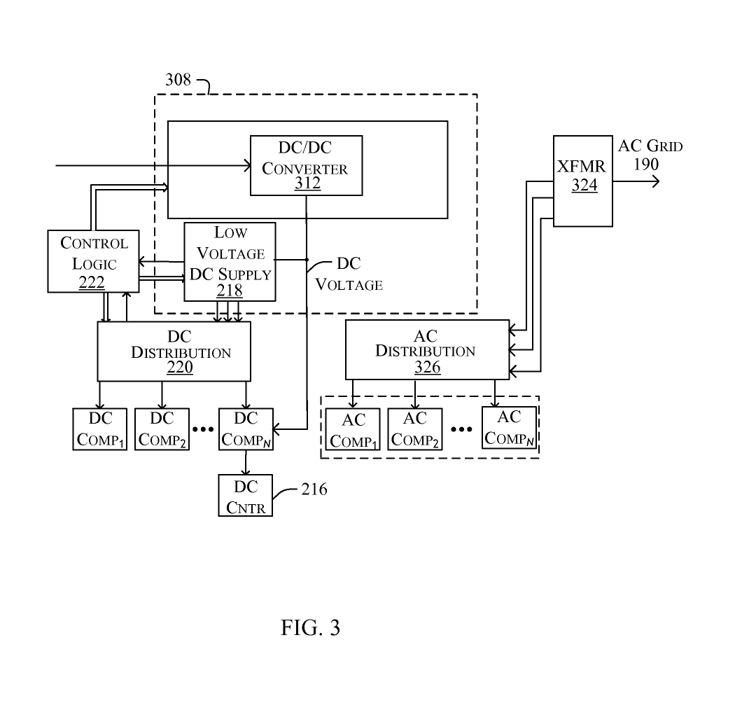

Referring to FIG. 3, shown is an exemplary LVRT component 308 that utilizes power solely from the array 102 to power inverter-related components during a low-voltage event. As shown, in this embodiment a DC-to-DC converter 312 may operate continually to apply power to the DC inverter-related components during both low voltage conditions and conditions when the AC grid 190 is operating at a nominal voltage. In this embodiment, the AC inverter-related components are powered by the AC grid (via a transformer 324 and an AC distribution component 326) during normal operation (when the voltages on the AC grid are at nominal values), and during a voltage sag on the AC grid, the AC distribution component 326 does not apply the AC power to the AC inverter-related components during the brief low voltage condition (e.g., AC fans and/or pumps are permitted to have the power to them interrupted).

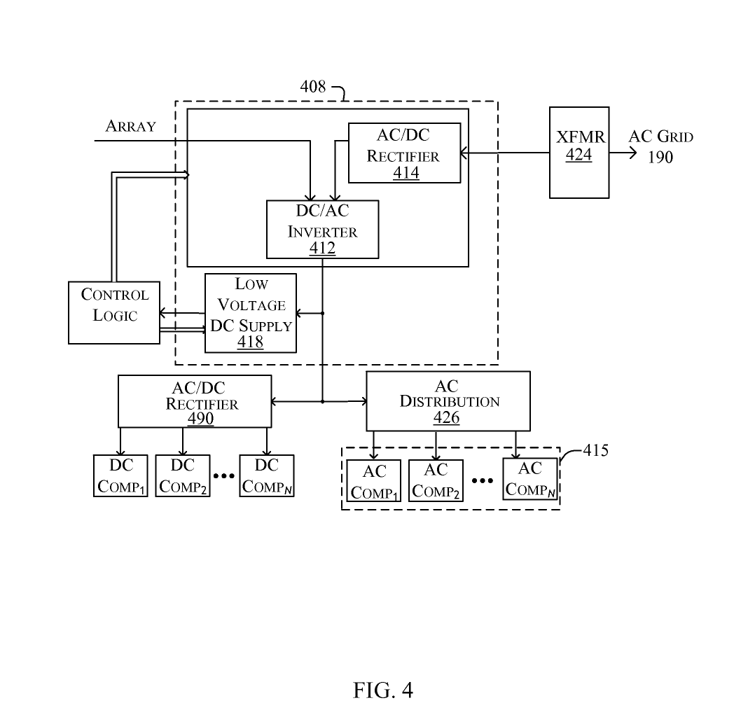

Referring next to FIG. 4, an AC-to-DC rectifier 414 can be used to supply power to a housekeeping inverter 412 that is also powered from the array. The AC output of the housekeeping inverter 412 can then be used to power necessary AC components 415 via an AC distribution system 426 and routed to an additional AC-to-DC rectifier 490 to supply DC voltage to DC components (e.g., switchgear). In addition, the housekeeping inverter 412 applies power to a AC-to-DC low voltage supply 418 that powers additional inverter-related housekeeping components including control logic and communications.

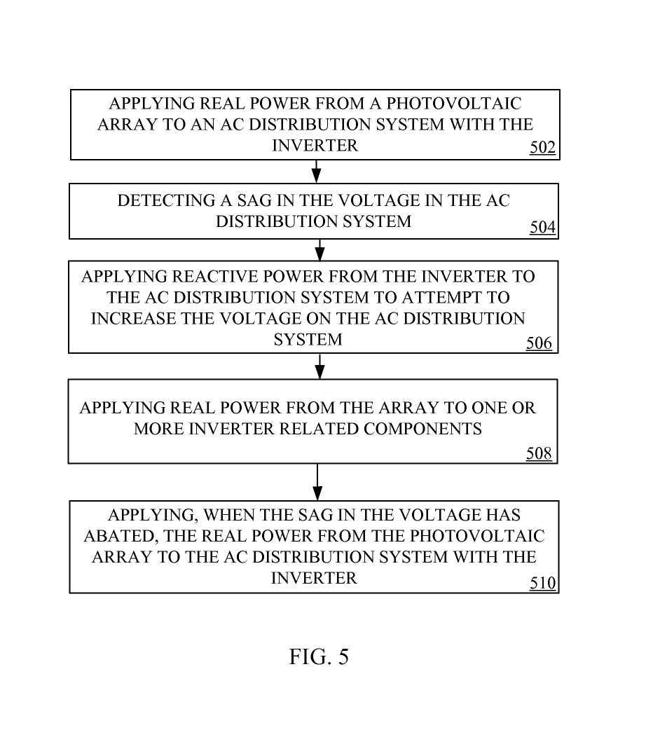

Referring next to FIG. 5, it is a flowchart depicting an exemplary method that may be traversed in connection with the embodiments described with reference to FIGS. 1-4. As shown, during normal operation, the inverter 100 applies real power from the array 102 to an AC grid 190 (Block 502), and when a voltage sag is detected on the AC grid 190 (Block 504), in some embodiments, using either active or passive methods, the output power of the inverter 100 may be modified to generate reactive power to help boost the voltage of the sagging line (Block 506).

Although not required, in some embodiments a secondary of a transformer (e.g., transformer 224, 324, 424) that is coupled to the AC grid 190 is monitored, and if the voltage at the secondary falls below a threshold (e.g., below 60, 70, 80, or 90 percent of its nominal value), then the AC grid 190 is considered to have a low voltage. And in response, the inverter 102 can take several different actions including generating reactive current in support of the sagging grid.

In the embodiments where reactive power is applied to the AC grid, the inverter 100 may capture a level of the output current of the inverter 100 when the sag is detected, and then hold the output current constant (as long as possible) while phase shifting the current to generate the reactive power.

And as shown, when there is a sag in the voltage in the AC grid 190, power from the array 102 is utilized to provide power to one or more inverter-related components (e.g., inverter-related components 106)(Block 508). The inverter-related components may include housekeeping type components such as, for example, control logic components (e.g., firmware, hardware, or software in non-transitory memory run on processing components), communication components (e.g., that enable an operator to control the inverter, receive inverter and array status information, and communicate with switching components that couple portions of the array 102 together), fans, pumps, and switch gear.

The duration of time during which the inverter 100 applies reactive power and the LVRT component 108, 208, 308, 408 applies power to the inverter-related components is configurable. In some instances, utilities and/or regulatory agencies have specific LVRT requirements. In some instances, the LVRT component 108, 208, 308, 408 may operate to provide power to essential inverter-related components for relatively long periods of time when there is a complete voltage drop on the AC grid 190. In some embodiments for example, the LVRT component 108, 208, 308, 408 may be implemented so that it may be configured to apply power at a selectable duration between one second and twenty seconds. And in other implementations, the LVRT component 108, 208, 308, 408 may be implemented to apply power between two seconds and ten seconds. In yet other embodiments, the LVRT component 108, 208, 308, 408 may be configured to operate for a specific period of time depending upon the level of voltage sag that occurs. In one particular application for example, the LVRT component 108, 208, 308, 408 may operate to provide power to essential inverter-related components for 2 seconds when there is a complete voltage drop on the AC grid 190, and may operate for 3.5 seconds when there is a 50% drop in voltage on the AC grid 190. In some embodiments of the LVRT component 108, 208, 308, 408, the power from the array 102 could be continuous. And in these embodiments, the grid connection 104 may be used to supplement power to the system when the array 102 is disconnected or conditions are not applicable for voltage to be present at the array terminals. It should also be recognized that the application of reactive power during a low voltage event is not required, and in other embodiments and/or other modes of operation, the inverter 100 does not apply reactive power during low voltage events.

As shown, once the sag in the voltage at the AC grid 190 has abated, predominately real power is applied once again from the inverter 100 to the AC grid 190 (Block 510). Although not required, the same voltage threshold that is used to prompt the application of reactive power during a low voltage event may be utilized to prompt the application of real power. For example, if a drop to 80% of nominal voltage triggers the LVRT-mode of operation, then a subsequent rise to 80% may prompt the LVRT component 108, 208, 308, 408 and inverter 100 to drop out of the low voltage ride though mode of operation and return to a normal operating mode. But again, this is certainly not required and the thresholds may be different.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein (e.g., control logic 222) may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the method described with reference to FIG. 5) may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A photovoltaic inverter with low-voltage-ride-through capability comprising:
an input to couple to a photovoltaic array;
an output to couple to an AC grid;
an inverter portion to convert a DC voltage at the input to an AC voltage at the output;
at least one management component to manage at least one aspect of the inverter portion; and
a low voltage ride through component including a power conversion component that utilizes, when there is a voltage sag in the AC grid, power from the photovoltaic array to apply power to the at least one management component.

2. The photovoltaic inverter of claim 1, wherein the power conversion component includes a DC-to-DC converter that converts DC power from the photovoltaic array and applies DC power to the at least one management component.

3. The photovoltaic inverter of claim 2 including a low voltage DC supply to down-convert DC power that is applied by the DC-to-DC converter to a lower DC voltage.

4. The photovoltaic inverter of claim 2 wherein the power conversion component includes an AC-to-DC rectifier to apply DC power to the at least one management component;
wherein outputs of the DC-to-DC converter and the AC-to-DC rectifier are coupled so that a voltage of the power that is applied to the at least one management component does not fall below a minimum level.

5. The photovoltaic inverter of claim 2, wherein the at least one management component includes a plurality of management components including DC and AC management components;
wherein at least one AC-powered management component is not powered when there is the voltage sag in the AC grid.

6. The photovoltaic inverter of claim 1, wherein the power conversion component includes an inverter to convert DC power from the photovoltaic array to AC power and apply the AC power to the at least one AC-powered management component.

7. The photovoltaic inverter of claim 6, including a rectifier to rectify the AC power from the inverter to produce DC power and apply the DC power to at least one DC powered management component.

8. The photovoltaic inverter of claim 1, wherein the at least one management component is selected from the group consisting of control logic, a fan, a pump, switchgear, and a communication component.

9. A method for powering components of an inverter during a low voltage event, the method comprising:
applying real power from a photovoltaic array to an AC grid with the inverter;
detecting a sag in the voltage in the AC grid;
utilizing, responsive to the sag in the voltage in the AC grid, power from the photovoltaic array to provide power to at least one inverter-related component; and
applying, when the sag in the voltage has abated, the real power from the photovoltaic array to the AC grid with the inverter.

10. The method of claim 9, including:
applying reactive power from the photovoltaic array to the AC grid to attempt to increase the voltage in the AC grid.

11. The method of claim 10, including:
holding the output current constant and phase shifting the current to generate the reactive power.

12. The method of claim 9, including:
utilizing power from the AC grid to power the at least one inverter-related component when there is no sag in the voltage in the AC grid.

13. The method of claim 9, including:
converting the power from the photovoltaic array to a another DC voltage; and
applying the other DC voltage to the at least one inverter-related component.

14. The method of claim 9, including:
converting the power from the photovoltaic array to an AC voltage; and
applying the AC voltage to an AC inverter-related component.

15. The method of claim 9, wherein the inverter-related component is selected from the group consisting of control logic, a fan, a pump, switch gear, and a communication component.

16. A photovoltaic inverter with low-voltage-ride-through capability comprising:
means for applying real power from a photovoltaic array to an AC grid with the inverter;
means for detecting a sag in the voltage in the AC grid;
means for utilizing, responsive to the sag in the voltage in the AC grid, power from the photovoltaic array to provide power to at least one inverter-related component; and
means for applying, when the sag in the voltage has abated, the real power from the photovoltaic array to the AC grid with the inverter.

17. The photovoltaic inverter of claim 16, including:
means for applying reactive power from the photovoltaic array to the AC grid to attempt to increase the voltage in the AC grid.

18. The photovoltaic inverter of claim 17, including:
means for holding the output current constant and phase shifting the current to generate the reactive power.

19. The photovoltaic inverter of claim 16, including:
means for utilizing power from the AC grid to power the at least one inverter-related component when there is no sag in the voltage in the AC grid.

20. The photovoltaic inverter of claim 16, including:
means for converting the power from the photovoltaic array to a another DC voltage; and
means for applying the other DC voltage to the at least one inverter-related component.

21. The photovoltaic inverter of claim 16, including:
means for converting the power from the photovoltaic array to an AC voltage; and
means for applying the AC voltage to an AC inverter-related component.
